(19) United States
(12) Patent Application Publication
(10) Pub. No.: US 2007/0075930 A1
(43) Pub. Date: Apr. 5, 2007

(54) METHOD OF DRIVING PLASMA DISPLAY APPARATUS

(75) Inventor: Oedong KIM, Seongnam-si Gyeonggi-do (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 11/463,656

(22) Filed: Aug. 10, 2006

(30) Foreign Application Priority Data
Aug. 10, 2005 (KR) 10-2005-0073491
Sep. 8, 2005 (KR) 10-2005-0083864

(51) Int. Cl. G09G 3/28

(52) U.S. Cl. 345/67

(57) ABSTRACT

A method of driving a plasma display apparatus is disclosed. The method of driving the plasma display apparatus including a first electrode, a second electrode and a third electrode, includes generating a first surface discharge during a reset period of a first subfield, generating a second surface discharge between the first electrode and the second electrode during the reset period of the first subfield, and generating a first opposite discharge between the first electrode and the third electrode during the reset period of the first subfield. The first surface discharge is generated by supplying a voltage of a first polarity to the first electrode and by supplying a voltage of a second polarity to the second electrode during the reset period of the first subfield.

This Nonprovisional application claims priority under 35 U.S.C. § 119(a) on Patent Application No. 10-2005-0073491 and 10-2005-0083864 filed in Korea on Aug. 10, 2005 and Sep. 8, 2005 the entire contents of which are hereby incorporated by reference.

### BACKGROUND OF THE INVENTION

1. Field of the Invention

This document relates to a method of driving a plasma display apparatus.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs form unit discharge cell or discharge cells. Each of the discharge cell is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

The plasma display panel displays the image by generating a sustain discharge during a sustain period of a subfield. The subfield comprises a reset period, an address period and a sustain period. During the reset period, wall charges of all the discharge cells of the plasma display panel remain uniform. During the address period, discharge cells where a sustain discharge will occur, are selected from all the discharge cells. During the sustain period, the sustain discharge occurs in the discharge cell selected during the address period. The driver of the plasma display apparatus supplies a driving pulse to a scan electrode, an address electrode and a sustain electrode of the plasma display apparatus.

### SUMMARY OF The INVENTION

In an aspect, there is provided a method of driving a plasma display apparatus comprising a first electrode, a second electrode and a third electrode, comprising supplying a voltage of a first polarity to the first electrode and supplying a voltage of a second polarity to the second electrode during a reset period of a first subfield to generate a first surface discharge, generating a second surface discharge between the first electrode and the second electrode during the reset period of the first subfield, and generating a first opposite discharge between the first electrode and the third electrode during the reset period of the first subfield.

In another aspect, there is provided a method of driving a plasma display apparatus comprising a first electrode, a second electrode and a third electrode, comprising generating a first surface discharge between the first electrode and the second electrode during a reset period of a subfield, and generating a second surface discharge weaker than the first surface discharge between the first electrode and the second electrode during the reset period of the subfield, wherein the first surface discharge is generated by supplying a sustain voltage to the second electrode, and the second surface discharge is generated by supplying a reference voltage to the second electrode.

In still another aspect, there is provided a method of driving a plasma display apparatus comprising a first electrode, a second electrode and a third electrode, comprising supplying a voltage of a first polarity to the first electrode and supplying a voltage of a second polarity to the second electrode during a reset period of a first subfield to generate a first surface discharge, generating a second surface discharge between the first electrode and the second electrode during the reset period of the first subfield, generating a first opposite discharge between the first electrode and the third electrode during the reset period of the first subfield, generating a third surface discharge between the first electrode and the second electrode during a reset period of a second subfield, and generating a fourth surface discharge weaker than the third surface discharge between the first electrode and the second electrode during the reset period of the second subfield, wherein the third surface discharge is generated by supplying a sustain voltage to the second electrode, and the fourth surface discharge is generated by supplying a reference voltage to the second electrode.

### BRIEF DESCRIPTION OF THE DRAWINGS

The embodiment of the invention will be described in detail with reference to the following drawings in which like numerals refer to like elements.

FIG. 1 illustrates a plasma display apparatus according to embodiments of the present invention;

FIG. 2 illustrates a method of driving a plasma display apparatus according to a first embodiment of the present invention;

FIG. 3 illustrates a method of driving a plasma display apparatus according to a second embodiment of the present invention;

FIG. 4 illustrates a method of driving a plasma display apparatus according to a third embodiment of the present invention;

FIG. 5 illustrates light output generated by the method of driving the plasma display apparatus according to the first to third embodiments of the present invention;

FIGS. 6, 7 and 8 illustrate a method of driving a plasma display apparatus according to a fourth embodiment of the present invention; and

FIG. 9 illustrates a method of driving a plasma display apparatus according to a fifth embodiment of the present invention.

### DETAILED DESCRIPTION OF PREFERRED EMBODIMENTS

Embodiments of the present invention will be described in a more detailed manner with reference to the drawings.

According to embodiments of the present invention, a method of driving a plasma display apparatus comprising a first electrode, a second electrode and a third electrode, comprises supplying a voltage of a first polarity to the first electrode and supplying a voltage of a second polarity to the second electrode during a reset period of a first subfield to generate a first surface discharge, generating a second surface discharge between the first electrode and the second electrode during the reset period of the first subfield, and generating a first opposite discharge between the first electrode and the third electrode during the reset period of the first subfield.

The method may further comprise generating a third surface discharge between the first electrode and the second electrode during a reset period of a second subfield, and generating a second opposite discharge between the first electrode and the third electrode during the reset period of the second subfield.

The first surface discharge may be generated by supplying a first voltage of the first polarity, which is maintained at the first voltage for a predetermined duration of time, to the first electrode, and by supplying a falling pulse gradually falling to a third voltage to the second electrode.

The first surface discharge may be generated by supplying a rising pulse rising from a first voltage to a second voltage to the first electrode, and by supplying a falling pulse gradually falling to a third voltage to the second electrode.

The second surface discharge may be generated by supplying a falling pulse gradually falling from a highest voltage level of the first polarity to a fourth voltage to the first electrode, and by supplying a fifth voltage of the first polarity to the second electrode.

The first opposite discharge may be generated by supplying a falling pulse falling from a sixth voltage to a seventh voltage of the second polarity to the first electrode, by supplying an eighth voltage, which is maintained at the eighth voltage for a predetermined duration of time, to the second electrode, and by supplying a reference voltage to the third electrode.

The first surface discharge may be generated by supplying a first voltage of the first polarity, which is maintained at the first voltage for a predetermined duration of time, to the first electrode, and by supplying a falling pulse gradually falling to a third voltage to the second electrode. The second surface discharge may be generated by supplying a falling pulse gradually falling from a highest voltage level of the first polarity to a fourth voltage to the first electrode, and by supplying a fifth voltage of the first polarity to the second electrode. The first opposite discharge may be generated by supplying a falling pulse falling from a sixth voltage to a seventh voltage of the second polarity to the first electrode, by supplying an eighth voltage, which is maintained at the eighth voltage for a predetermined duration of time, to the second electrode, and supplying a reference voltage to the third electrode. A slope of the falling pulse of the first surface discharge may be substantially equal to a slope of the falling pulse of the second surface discharge or a slope of the falling pulse of the first opposite discharge.

The first surface discharge may be generated by supplying a first voltage of the first polarity, which is maintained at the first voltage for a predetermined duration of time, to the first electrode, and by supplying a falling pulse gradually falling to a third voltage to the second electrode. The second surface discharge may be generated by supplying a falling pulse gradually falling from a highest voltage level of the first polarity to a fourth voltage to the first electrode, and by supplying a fifth voltage of the first polarity to the second electrode. The first opposite discharge may be generated by supplying a falling pulse falling from a sixth voltage to a seventh voltage of the second polarity to the first electrode, by supplying an eighth voltage, which is maintained at the eighth voltage for a predetermined duration of time, to the second electrode, and by supplying a reference voltage to the third electrode. The lowest voltage of the falling pulse of the first surface discharge may be substantially equal to the lowest voltage of the falling pulse of the first opposite discharge.

The first opposite discharge may be generated by supplying a falling pulse falling from a sixth voltage to a seventh voltage of the second polarity to the first electrode, by supplying a falling pulse falling from an eighth voltage to a ninth voltage to the second electrode, and by supplying a reference voltage to the third electrode.

The second opposite discharge may be generated by supplying a falling pulse falling from a sixth voltage to a seventh voltage of the second polarity to the first electrode, by supplying a falling pulse falling from an eighth voltage to a ninth voltage to the second electrode, and supplying a reference voltage to the third electrode.

The first polarity may be a positive polarity, and the second polarity may be a negative polarity.

The first polarity may be a negative polarity, and the second polarity may be a positive polarity.

The first subfield may be a first located subfield of a frame.

The method may further comprise generating a third surface discharge between the first electrode and the second electrode during a reset period of a second subfield, and generating a second opposite discharge between the first electrode and the third electrode during the reset period of the second subfield. The second surface discharge and the third surface discharge may be generated by supplying a falling pulse gradually falling from a highest voltage level of the first polarity to a fourth voltage to the first electrode, and by supplying a fifth voltage of the first polarity to the second electrode.

A slope of the rising pulse may be equal to or less than 1.

According to the embodiments of the present invention, a method of driving a plasma display apparatus comprising a first electrode, a second electrode and a third electrode, comprises generating a first surface discharge between the first electrode and the second electrode during a reset period of a subfield, and generating a second surface discharge weaker than the first surface discharge between the first electrode and the second electrode during the reset period of the subfield, wherein the first surface discharge is generated by supplying a sustain voltage to the second electrode, and the second surface discharge is generated by supplying a reference voltage to the second electrode.

An energy recovery circuit may supply the sustain voltage.

A duration of time of the supply of the sustain voltage supplied during the subfield may be equal to or more than a duration of time of the supply of a sustain voltage of a sustain pulse supplied during a sustain period of a previous subfield of the subfield.

After the energy recovery circuit supplies the sustain voltage, the energy recovery circuit may supply a falling pulse gradually falling from the sustain voltage to a reference voltage to the second electrode.

The first surface discharge may be generated by supplying a predetermined voltage to the first electrode for a first duration of time, and by supplying the sustain voltage to the second electrode for a second duration of time. A portion of the first duration of time may overlap a portion of the second duration of time.

The second surface discharge may be generated by supplying a predetermined voltage to the first electrode for a first duration of time, and by supplying a reference voltage to the second electrode for a second duration of time. A portion of the first duration of time overlaps a portion of the second duration of time.

The subfield may be located subsequent to a first located subfield of a frame.

According to the embodiments of the present invention, a method of driving a plasma display apparatus comprising a first electrode, a second electrode and a third electrode, comprises supplying a voltage of a first polarity to the first electrode and supplying a voltage of a second polarity to the second electrode during a reset period of a first subfield to generate a first surface discharge, generating a second surface discharge between the first electrode and the second electrode during the reset period of the first subfield, generating a first opposite discharge between the first electrode and the third electrode during the reset period of the first subfield, generating a third surface discharge between the first electrode and the second electrode during a reset period of a second subfield, and generating a fourth surface discharge weaker than the third surface discharge between the first electrode and the second electrode during the reset period of the second subfield, wherein the third surface discharge is generated by supplying a sustain voltage to the second electrode, and the fourth surface discharge is generated by supplying a reference voltage to the second electrode.

The first subfield and the second subfield may be located adjacent to each other.

A sustain period of the first subfield may be adjacent to a reset period of the second subfield.

Hereinafter, exemplary embodiments of the present invention will be described in detail with reference to the attached drawings.

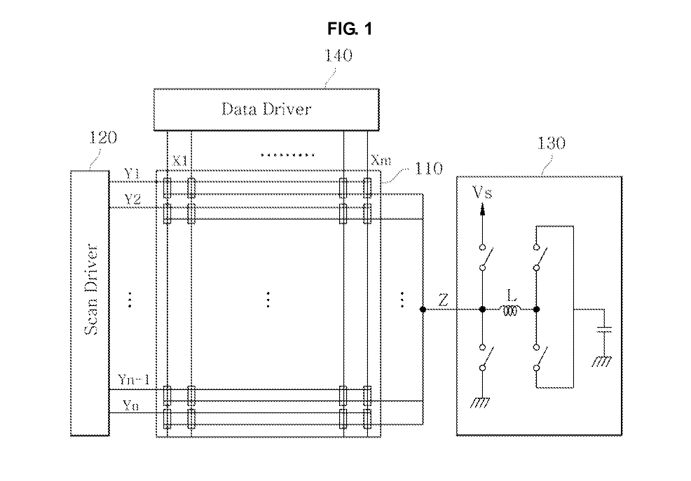

FIG. 1 illustrates a plasma display apparatus according to embodiments of the present invention. As illustrated in FIG. 1, the plasma display apparatus according to the embodiments of the present invention comprises a plasma display panel 110, a scan driver 120, a sustain driver 130 and a data driver 140.

The plasma display panel 110 comprises scan electrodes Y1 to Yn, sustain electrodes Z and address electrodes X1 to Xm. The plasma display panel 110 is supplied with a driving pulse through at least one of the scan electrodes Y1 to Yn, the sustain electrodes Z and the address electrodes X1 to Xm to display an image corresponding to an image signal.

During a reset period of a first subfield of a frame, the scan driver 120 supplies a positive voltage to the scan electrodes Y1 to Yn, and the sustain driver 130 supplies a negative voltage to the sustain electrodes Z, thereby generating a first surface discharge. After generating the first surface discharge, the scan driver 120 and the sustain driver 130 generate a second surface discharge between the scan electrodes Y1 to Yn and the sustain electrodes Z. After generating the second surface discharge, the scan driver 120 and the data driver 140 generate a first opposite discharge between the scan electrodes Y1 to Yn and the address electrodes X1 to Xm.

During a reset period of a second subfield of the frame, the scan driver 120 and the sustain driver 130 generate a third surface discharge between the scan electrodes Y1 to Yn and the sustain electrodes Z. After generating the third surface discharge, the scan driver 120 and the sustain driver 130 generate a fourth surface discharge between the scan electrodes Y1 to Yn and the sustain electrodes Z. After generating the fourth surface discharge, the scan driver 120 and the data driver 140 generate a second opposite discharge between the scan electrodes Y1 to Yn and the address electrodes X1 to Xm. A sustain voltage Vs is supplied to the sustain electrodes Z such that the third surface discharge is generated. A reference voltage of a ground level is supplied to the sustain electrodes Z such that the fourth surface discharge is generated.

A frame may comprise at least one of the first subfield in which the first surface discharge, the second surface discharge and the first opposite discharge are generated, or the second subfield in which the third surface discharge, the fourth surface discharge and the second opposite discharge are generated. In other words, the plasma display apparatus according to the embodiments of the present invention can drive the plasma display panel 110 during the frame comprising the first subfield and the second subfield, or can drive the plasma display panel 110 during the frame comprising the first subfield, or can drive the plasma display panel 110 during the frame comprising the second subfield.

A method of driving the above-described plasma display apparatus according to the embodiments of the present invention will be described in detail with reference to the attached drawings.

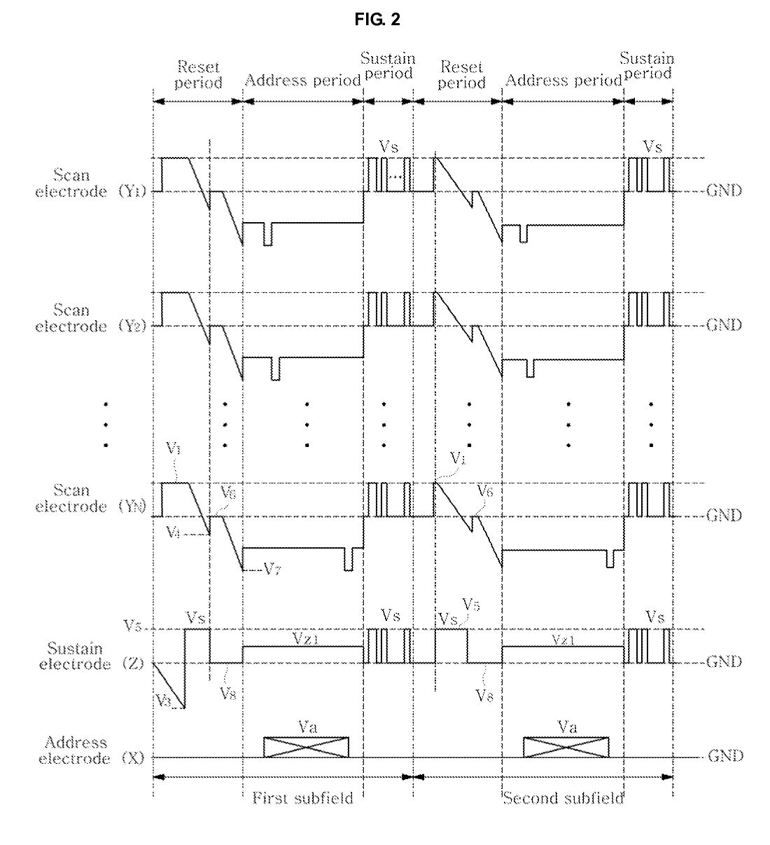

FIG. 2 illustrates a method of driving a plasma display apparatus according to a first embodiment of the present invention. As illustrated in FIG. 2, in the method of driving the plasma display apparatus according to the first embodiment of the present invention, during a reset period of a first subfield, a surface discharge occurs between the scan electrodes Y1 to Yn and the sustain electrodes Z two times, and an opposite discharge occurs between the scan electrodes Y1 to Yn and the address electrodes X1 to Xm once.

A first voltage V1 of a positive polarity, which is maintained at the first voltage for a predetermined duration of time, is supplied to the scan electrodes Y1 to Yn, and a falling pulse gradually falling from a ground level voltage to a third voltage V3 of a negative polarity is supplied to the sustain electrodes Z. This results in an increase in a voltage difference between the scan electrodes Y1 to Yn and the sustain electrodes Z, and thus generating a first surface discharge. The first surface discharge accumulates a sufficient amount of initial wall charges on a discharge cell of a plasma display panel. The first voltage V1 may be substantially equal to a sustain voltage Vs for generating a sustain pulse supplied during a sustain period.

A falling pulse gradually falling from the first voltage V1 to a fourth voltage V4 of a negative polarity is supplied to the scan electrodes Y1 to Yn, and a fifth voltage V5 of a positive polarity is supplied to the sustain electrodes Z. This results in an increase in a voltage difference between the scan electrodes Y1 to Yn and the sustain electrodes Z, and thus generating a second surface discharge. The fifth voltage V5 may be substantially equal to the sustain voltage Vs. Since the voltage difference between the scan electrodes Y1 to Yn and the sustain electrodes Z for generating the second surface discharge is less than the voltage difference between the scan electrodes Y1 to Yn and the sustain electrodes Z for generating the first surface discharge, a discharge intensity of the second surface discharge is less than a discharge intensity of the first surface discharge. Accordingly, a proper amount of wall charges accumulated by performing the first surface discharge are erased.

A falling pulse gradually falling from a sixth voltage V6 of a ground level to a seventh voltage V7 of a negative polarity is supplied to the scan electrodes Y1 to Yn, an eighth voltage V8, which is maintained at the eighth voltage for a predetermined duration of time, is supplied to the sustain electrodes Z, and a reference voltage of a ground level is supplied to the address electrodes X. This results in an increase in a voltage difference between the scan electrodes Y1 to Yn and the address electrodes X, and thus generating a first opposite discharge. The first opposite discharge accumulates a proper amount of wall charges on the scan electrodes Y1 to Yn and the address electrodes X.

To easily operate of the scan driver 120, the sustain driver 130 and the data driver 140, a slope of the falling pulse for generating the first surface discharge may be substantially equal to at least one of a slope of the falling pulse for generating the second surface discharge or a slope of the falling pulse for generating the first opposite discharge. Further, to simplify the structure of each of the scan driver 120 and the sustain driver 130, the third voltage V3 for generating the first surface discharge may be substantially equal to the seventh voltage V7 for generating the first opposite discharge.

Since the wall charges are sufficiently accumulated during the reset period of the first subfield, a setup pulse with a high voltage level may not be supplied during a reset period of a second subfield. In other words, a setup pulse is not supplied the scan electrodes Y1 to Yn in the second subfield and subfields subsequent to the second subfield. A falling pulse gradually falling from the first voltage V1 is supplied to the scan electrodes Y1 to Yn, and a fifth voltage V5, which is maintained at the fifth voltage for a predetermined duration of time, is supplied to the sustain electrodes Z. This results in generating a third surface discharge between the scan electrodes Y1 to Yn and the sustain electrodes Z. Further, a falling pulse falling from the sixth voltage V6 of a ground level is supplied to the scan electrodes Y1 to Yn, the eighth voltage V8 of a ground level is supplied to the sustain electrodes Z, and the reference voltage of a ground level is supplied to the address electrodes X. This results in an increase in a voltage difference between the scan electrodes Y1 to Yn and the address electrodes X, and thus generating a second opposite discharge. The method of driving the plasma display apparatus according to the first embodiment of the present invention may start to be carried out in the first subfield of the frame.

In the method of driving the plasma display apparatus according to the first embodiment of the present invention, a sufficient amount of wall charges are formed by the first surface discharge, the amount of wall charges are maintained at a proper level formed by the second surface discharge, and the amount of wall charges formed between the scan electrode and the address electrode is properly adjusted by the first opposite discharge such that an address discharge occurs easily during an address period. Accordingly, a jitter characteristic of the plasma display apparatus is improved. Further, since the falling pulse falling to the third voltage V3 of the negative voltage level is supplied to the sustain electrodes Z during the reset period, the surface discharge occurs between the scan electrodes X1 to Xn and the sustain electrodes Z without the supply of a setup pulse with a high voltage level and the opposite discharge does not occur between the scan electrodes X1 to Xn and the address electrodes X. Accordingly, a contrast characteristic of the plasma display apparatus is improved.

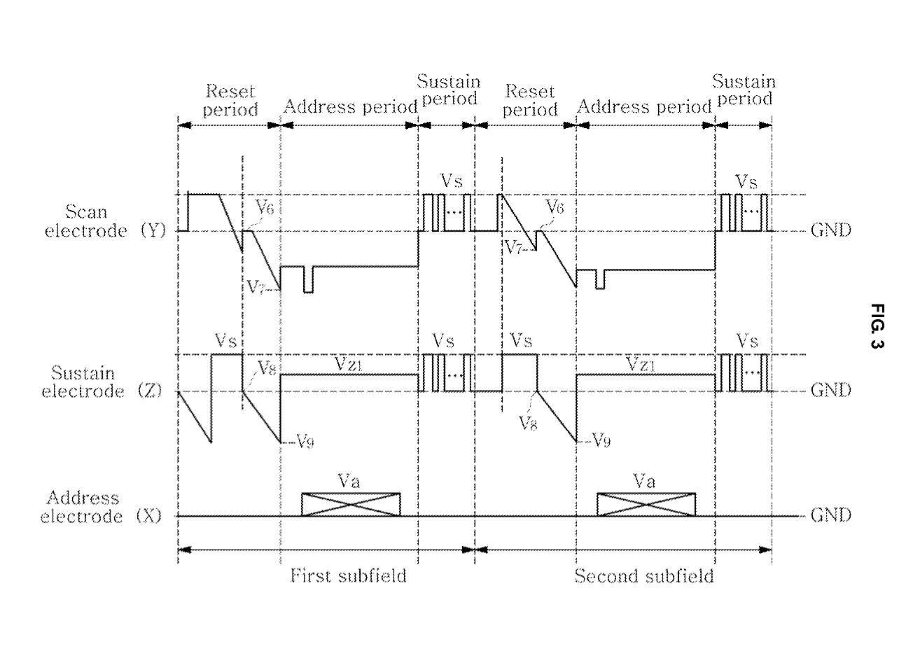

FIG. 3 illustrates a method of driving a plasma display apparatus according to a second embodiment of the present invention. Since a first surface discharge, a second surface discharge and a third surface discharge in the method of driving the plasma display apparatus according to the second embodiment of the present invention are the same as those in the method of driving the plasma display apparatus according to the first embodiment of the present invention, a description thereof is omitted.

During reset periods of a first subfield and a second subfield, a falling pulse falling from a sixth voltage V6 of a ground level to a seventh voltage V7 of a negative polarity is supplied to the scan electrodes Y1 to Yn, a falling pulse falling from an eighth voltage V8 to a ninth voltage V9 is supplied to the sustain electrodes Z, and a reference voltage of a ground level is supplied to the address electrodes X, thereby generating a first opposite surface and a second opposite surface. Since a voltage difference between the scan electrodes Y1 to Yn and the sustain electrodes Z in the second embodiment is less than the voltage difference between the scan electrodes Y1 to Yn and the sustain electrodes Z in the first embodiment, wall charges are sufficiently accumulated on the scan electrodes Y1 to Yn and the address electrodes X. Accordingly, a jitter characteristic of the plasma display apparatus is improved. The method of driving the plasma display apparatus according to the second embodiment of the present invention may start to be carried out in the first subfield of the frame.

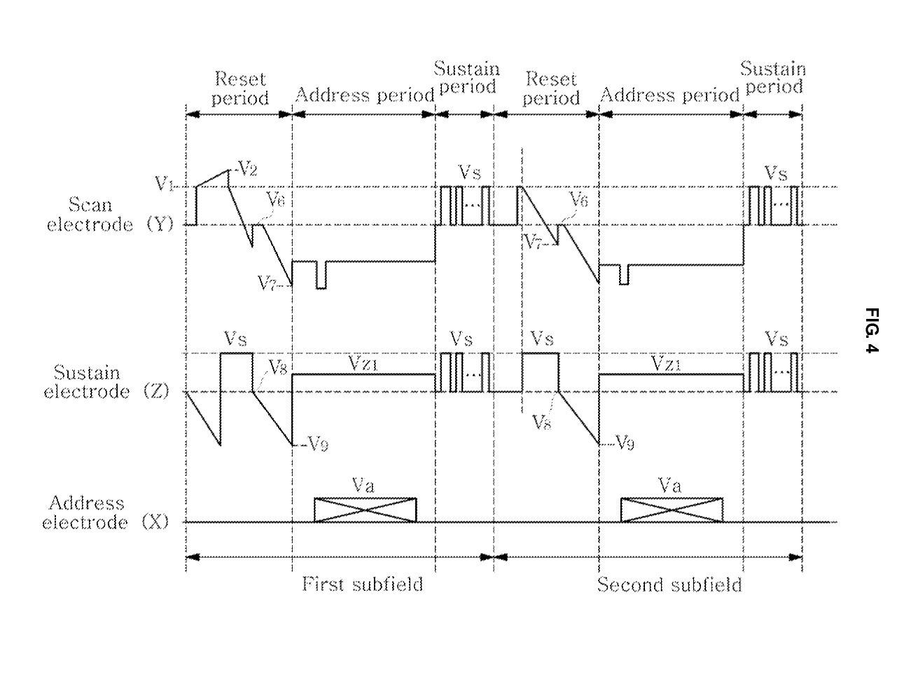

FIG. 4 illustrates a method of driving a plasma display apparatus according to a third embodiment of the present invention. Since a second surface discharge, a third surface discharge, a first opposite discharge and a second opposite discharge in the method of driving the plasma display apparatus according to the third embodiment of the present invention are the same as those in the method of driving the plasma display apparatus according to the second embodiment of the present invention, a description thereof is omitted.

As illustrated in FIG. 4, during a reset period of a first subfield, a rising pulse gradually rising from a first voltage V1 to a second voltage V2 is supplied to the scan electrodes Y1 to Yn, and a falling pulse gradually falling to a third voltage V3 is supplied to the sustain electrodes Z, thereby generating a first surface discharge. Unlike the method of driving the plasma display apparatus according the first and second embodiments, in the method of driving the plasma display apparatus according the third embodiment, since the rising pulse for generating the first surface discharge is supplied to the scan electrodes Y1 to Yn, the amount of wall charges formed on the scan electrodes Y1 to Yn and the sustain electrodes Z in the third embodiment is more than the amount of wall charges formed on the scan electrodes Y1 to Yn and the sustain electrodes Z in the first and second embodiments. Further, since the rising pulse is a ramp pulse, an influence of the rising pulse on a contrast characteristic of the plasma display apparatus can be minimized. A slope of the rising pulse supplied to the scan electrodes Y1 to Yn may be equal to or less than 1.

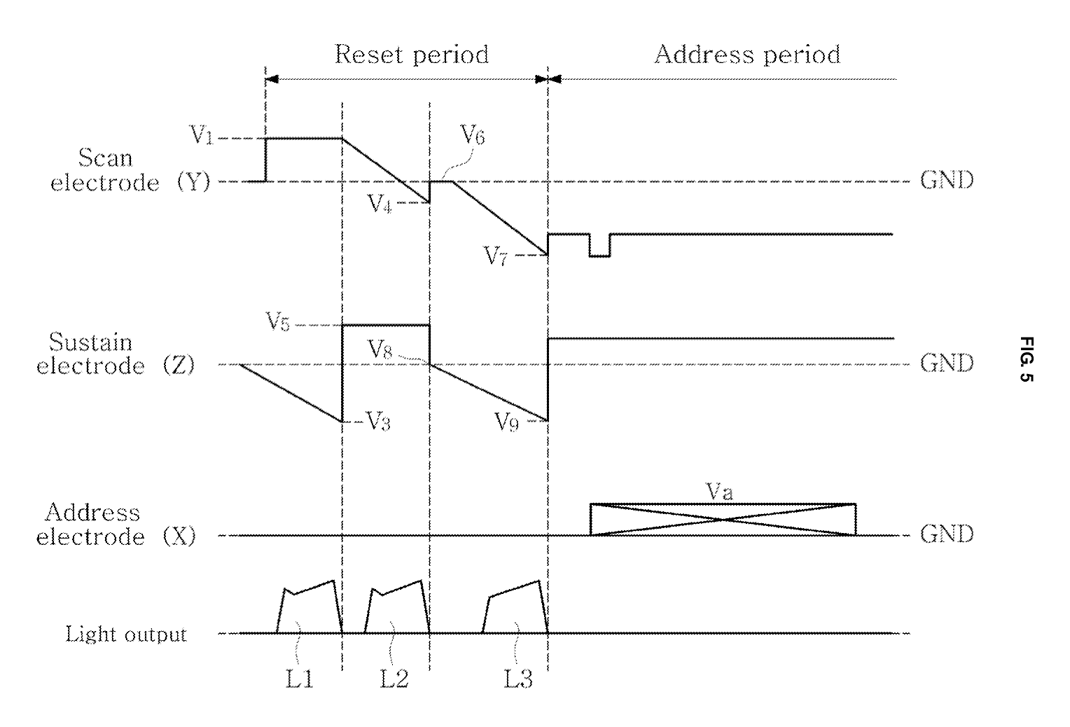

FIG. 5 illustrates light output generated by the method of driving the plasma display apparatus according to the first to third embodiments of the present invention. As illustrated in FIG. 5, the first surface discharge occurs by supplying the first voltage V1 of the positive polarity, which is maintained at the first voltage for the predetermined duration of time, to the scan electrodes Y1 to Yn, and by supplying the falling pulse gradually falling from the ground level voltage to the third voltage V3 of the negative polarity to the sustain electrodes Z. Accordingly, the wall charge are sufficiently accumulated on the scan electrodes Y1 to Yn and the sustain electrodes Z. A first light output L1 is generated due to the first surface discharge.

The second surface discharge occurs by supplying the falling pulse gradually falling from the first voltage V1 to the fourth voltage V4 of the negative polarity to the scan electrodes Y1 to Yn, and by supplying the fifth voltage V5 of the positive polarity to the sustain electrodes Z. A portion of negative charges formed on the scan electrodes Y1 to Yn moves to the sustain electrodes Z, and a portion of positive charges formed on the sustain electrodes Z moves to the scan electrodes Y1 to Yn. A second light output L2 is generated due to the second surface discharge.

The first opposite discharge occurs by supplying the falling pulse falling from the sixth voltage V6 of the ground level to the seventh voltage V7 of the negative polarity to the scan electrodes Y1 to Yn, by supplying the falling pulse falling from the eighth voltage V8 to the ninth voltage V9 to the sustain electrodes Z, and by supplying the reference voltage of the ground level to the address electrodes X. A magnitude of a third light output L3 generated due to the first opposite discharge is less than a magnitude of the first light output L1 and a magnitude of the second light output L2.

Since the setup pulse of the high voltage level is not supplied during the reset period in the method of driving the plasma display apparatus according to the embodiments of the present invention, a total magnitude of the light output decreases. Further, since the amount of wall charges formed on the electrodes is adjusted due to the second surface discharge and the first opposite discharge, the jitter characteristic of the plasma display apparatus is improved.

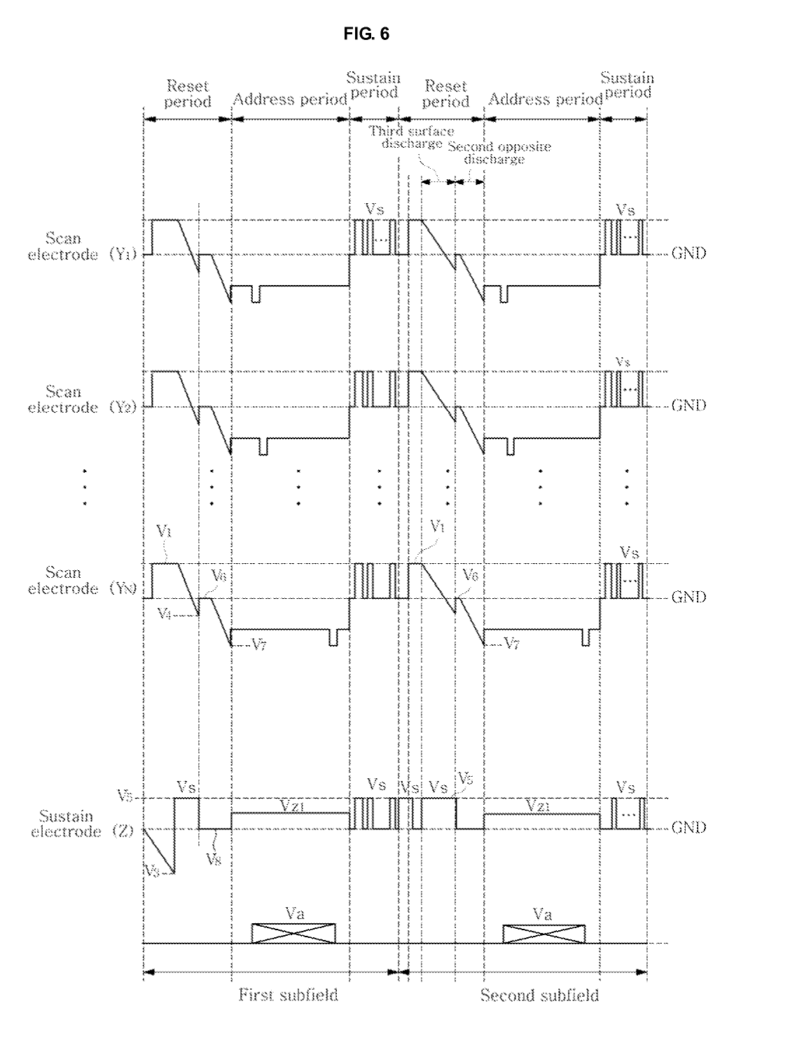

FIGS. 6, 7 and 8 illustrate a method of driving a plasma display apparatus according to a fourth embodiment of the present invention. Since a first surface discharge, a second surface discharge, a first opposite discharge, a third surface discharge and a second opposite discharge generated during a reset period of a first subfield in the method of driving the plasma display apparatus according to the fourth embodiment of the present invention are the same as those in the method of driving the plasma display apparatus according to the first embodiment of the present invention, a description thereof is omitted.

In the fourth embodiment of the present invention, before generating the third surface discharge during a reset period of a second subfield, a first adjustment surface discharge and a second adjustment surface discharge are generated. In other words, the first adjustment surface discharge is generated between the scan electrodes Y1 to Yn and the sustain electrodes Z during the reset period of the second subfield. After generating the first adjustment surface discharge, the second adjustment surface discharge is generated between the scan electrodes Y1 to Yn and the sustain electrodes Z during the reset period of the second subfield. To generate the first adjustment surface discharge, a sustain voltage Vs is supplied to the sustain electrodes Z. The sustain voltage Vs is supplied to the sustain electrode Z to generate a sustain pulse during a sustain period of the first subfield. A first voltage V1 is supplied during a portion of a duration of time of the supply of the sustain voltage Vs to the sustain electrode Z. The first voltage V1 may be substantially equal to the sustain voltage Vs. To generate the second adjustment surface discharge, a reference voltage is supplied to the sustain electrodes Z. The reference voltage may be substantially equal to a ground level voltage. The first voltage V1 is continuously supplied to the scan electrodes Y1 to Yn during a duration of time of the supply of the reference voltage to the sustain electrode Z.

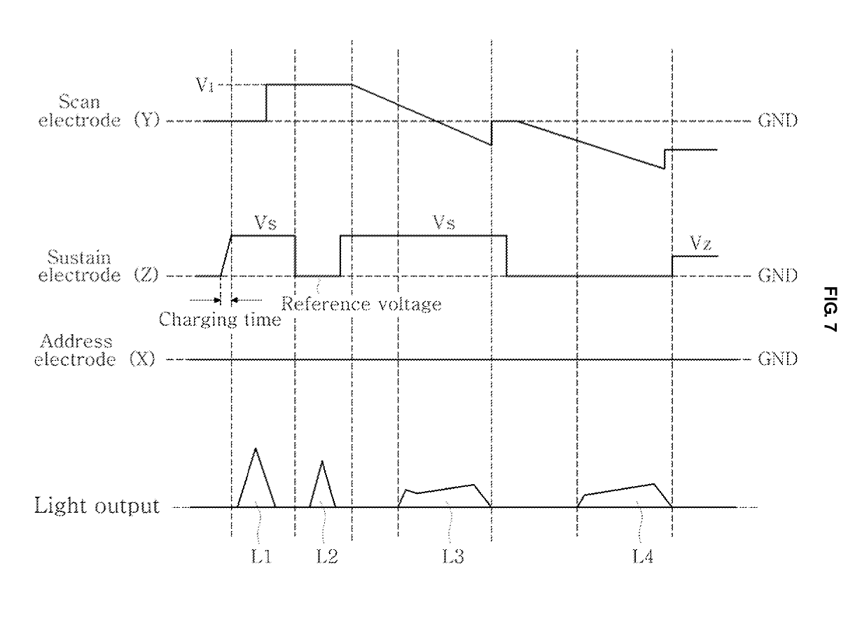

As illustrated in FIG. 7, the first voltage V1 is abruptly supplied to the scan electrodes Y during a portion of a duration of time of the supply of the sustain voltage Vs to the sustain electrode Z such that the first adjustment surface discharge is generated. The reference voltage is supplied to the sustain electrode Z during a portion of a duration of time of the supply of the first voltage V1 to the scan electrodes Y such that the second adjustment surface discharge is generated. Charging time illustrated in FIG. 7 is time required to supply a reactive energy to the sustain electrodes Z due to resonance, which is generated between an inductor L of an energy recovery circuit included in the sustain driver 130 of FIG. 1 and the plasma display panel. An intensity of a light output L1 of the first adjustment surface discharge is more than an intensity of a light output L2 of the second adjustment surface discharge.

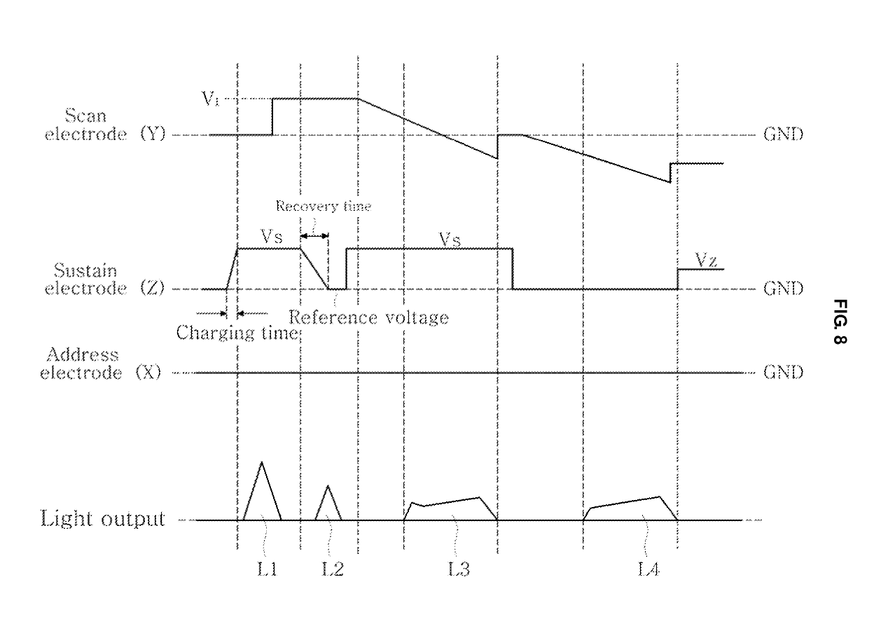

Recovery time illustrated in FIG. 8 is time required to recover the reactive energy from the sustain electrodes Z due to the resonance, which is generated between the inductor L of the energy recovery circuit of the sustain driver 130 of FIG. 1 and the plasma display panel. In particular, a voltage gradually changes when recovering the reactive energy from the sustain electrodes Z, the intensity of the light output L2 of the second adjustment surface discharge decreases.

Maintaining time of the sustain voltage supplied to the sustain electrode Z for generating the first adjustment surface discharge and the second adjustment surface discharge of FIGS. 6 to 8 may be more than maintaining time of the sustain voltage of the sustain pulse supplied during the sustain period of the first subfield.

In the method of driving the plasma display apparatus according to the fourth embodiment of the present invention, the amount of wall charges accumulated on the scan electrode and the sustain electrode can be minutely adjusted through the first adjustment surface discharge and the second adjustment surface discharge generated before generating the third surface discharge. In particular, the amount of wall charges accumulated on the scan electrode and the sustain electrode can be minutely adjusted through the control of the charging time required in the supply of the reactive energy to the sustain electrode Z or the recovery time required in the recovery of the reactive energy from the sustain electrode Z by the energy recovery circuit of the sustain driver 130. In FIGS. 7 and 8, the charging time and the recovery time for generating the first adjustment surface discharge and the second adjustment surface discharge are required. However, only the sustain voltage may be supplied without the charging time and the recovery time. The wall charges remain uniform through the first adjustment surface discharge and the second adjustment surface discharge.

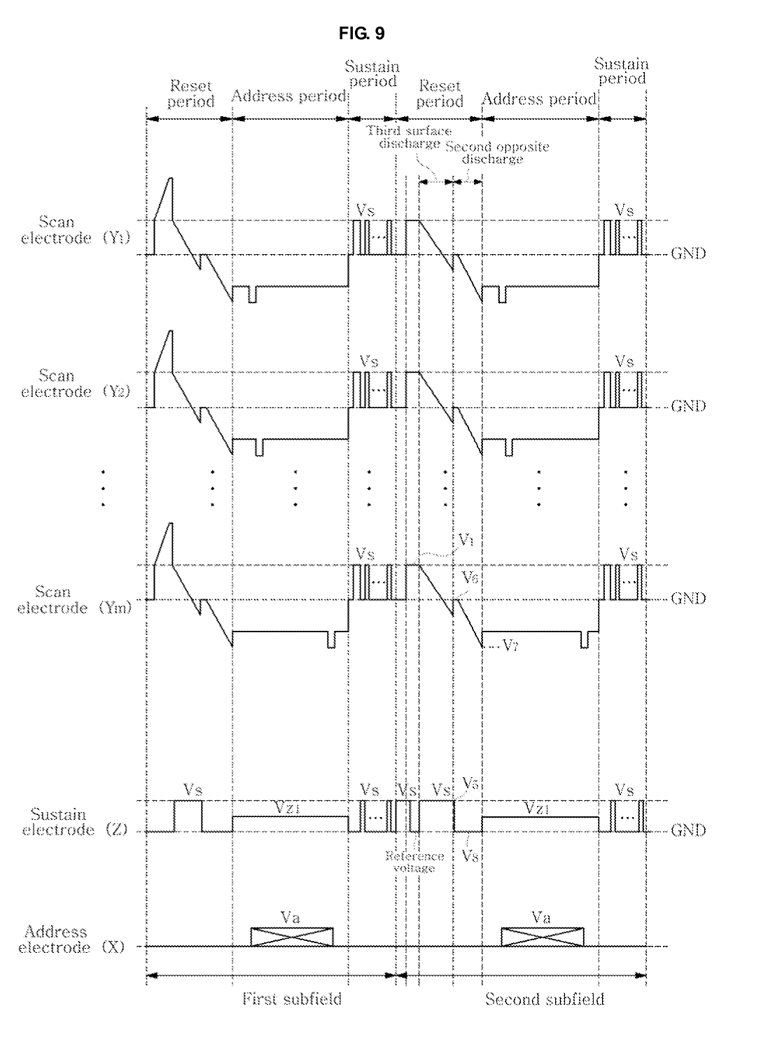

FIG. 9 illustrates a method of driving a plasma display apparatus according to a fifth embodiment of the present invention. As illustrated in FIG. 9, the method of driving the plasma display apparatus according to the fifth embodiment of the present invention generates a first surface discharge, a second surface discharge and a first opposite discharge in a first subfield, and generates a first adjustment surface discharge, a second adjustment surface discharge, a third surface discharge and a second opposite discharge in a second subfield. Since these discharges are same as the discharges described in the first embodiment and the fourth embodiment, a description thereof is omitted.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a plasma display apparatus comprising a first electrode, a second electrode and a third electrode, comprising:
supplying a voltage of a first polarity to the first electrode and supplying a voltage of a second polarity to the second electrode during a reset period of a first subfield to generate a first surface discharge;
generating a second surface discharge between the first electrode and the second electrode during the reset period of the first subfield; and
generating a first opposite discharge between the first electrode and the third electrode during the reset period of the first subfield.

2. The method of claim 1, further comprising generating a third surface discharge between the first electrode and the second electrode during a reset period of a second subfield, and generating a second opposite discharge between the first electrode and the third electrode during the reset period of the second subfield.

3. The method of claim 1, wherein the first surface discharge is generated by supplying a first voltage of the first polarity, which is maintained at the first voltage for a predetermined duration of time, to the first electrode, and by supplying a falling pulse gradually falling to a third voltage to the second electrode.

4. The method of claim 1, wherein the first surface discharge is generated by supplying a rising pulse rising from a first voltage to a second voltage to the first electrode, and by supplying a falling pulse gradually falling to a third voltage to the second electrode.

5. The method of claim 1, wherein the second surface discharge is generated by supplying a falling pulse gradually falling from a highest voltage level of the first polarity to a fourth voltage to the first electrode, and by supplying a fifth voltage of the first polarity to the second electrode.

6. The method of claim 1, wherein the first opposite discharge is generated by supplying a falling pulse falling from a sixth voltage to a seventh voltage of the second polarity to the first electrode, by supplying an eighth voltage, which is maintained at the eighth voltage for a predetermined duration of time, to the second electrode, and by supplying a reference voltage to the third electrode.

7. The method of claim 1, wherein the first surface discharge is generated by supplying a first voltage of the first polarity, which is maintained at the first voltage for a predetermined duration of time, to the first electrode, and by supplying a falling pulse gradually falling to a third voltage to the second electrode,
the second surface discharge is generated by supplying a falling pulse gradually falling from a highest voltage level of the first polarity to a fourth voltage to the first electrode, and by supplying a fifth voltage of the first polarity to the second electrode,
the first opposite discharge is generated by supplying a falling pulse falling from a sixth voltage to a seventh voltage of the second polarity to the first electrode, by supplying an eighth voltage, which is maintained at the eighth voltage for a predetermined duration of time, to the second electrode, and supplying a reference voltage to the third electrode, and
a slope of the falling pulse of the first surface discharge is substantially equal to a slope of the falling pulse of the second surface discharge or a slope of the falling pulse of the first opposite discharge.

8. The method of claim 1, wherein the first surface discharge is generated by supplying a first voltage of the first polarity, which is maintained at the first voltage for a predetermined duration of time, to the first electrode, and by supplying a falling pulse gradually falling to a third voltage to the second electrode,
the second surface discharge is generated by supplying a falling pulse gradually falling from a highest voltage level of the first polarity to a fourth voltage to the first electrode, and by supplying a fifth voltage of the first polarity to the second electrode,
the first opposite discharge is generated by supplying a falling pulse falling from a sixth voltage to a seventh voltage of the second polarity to the first electrode, by supplying an eighth voltage, which is maintained at the eighth voltage for a predetermined duration of time, to the second electrode, and by supplying a reference voltage to the third electrode, and
the lowest voltage of the falling pulse of the first surface discharge is substantially equal to the lowest voltage of the falling pulse of the first opposite discharge.

9. The method of claim 1, wherein the first opposite discharge is generated by supplying a falling pulse falling from a sixth voltage to a seventh voltage of the second polarity to the first electrode, by supplying a falling pulse falling from an eighth voltage to a ninth voltage to the second electrode, and by supplying a reference voltage to the third electrode.

10. The method of claim 2, wherein the second opposite discharge is generated by supplying a falling pulse falling from a sixth voltage to a seventh voltage of the second polarity to the first electrode, by supplying a falling pulse falling from an eighth voltage to a ninth voltage to the second electrode, and supplying a reference voltage to the third electrode.

11. The method of claim 1, wherein the first polarity is a positive polarity, and the second polarity is a negative polarity.

12. The method of claim 1, wherein the first polarity is a negative polarity, and the second polarity is a positive polarity.

13. The method of claim 1, wherein the first subfield is a first located subfield of a frame.

14. The method of claim 1, further comprising generating a third surface discharge between the first electrode and the second electrode during a reset period of a second subfield, and generating a second opposite discharge between the first electrode and the third electrode during the reset period of the second subfield,
wherein the second surface discharge and the third surface discharge are generated by supplying a falling pulse gradually falling from a highest voltage level of the first polarity to a fourth voltage to the first electrode, and by supplying a fifth voltage of the first polarity to the second electrode.

15. The method of claim 4, wherein a slope of the rising pulse is equal to or less than 1.

16. A method of driving a plasma display apparatus comprising a first electrode, a second electrode and a third electrode, comprising:
generating a first surface discharge between the first electrode and the second electrode during a reset period of a subfield; and
generating a second surface discharge weaker than the first surface discharge between the first electrode and the second electrode during the reset period of the subfield,
wherein the first surface discharge is generated by supplying a sustain voltage to the second electrode, and the second surface discharge is generated by supplying a reference voltage to the second electrode.

17. The method of claim 16, wherein an energy recovery circuit supplies the sustain voltage.

18. The method of claim 16, wherein a duration of time of the supply of the sustain voltage supplied during the subfield is equal to or more than a duration of time of the supply of a sustain voltage of a sustain pulse supplied during a sustain period of a previous subfield of the subfield.

19. The method of claim 17, wherein after the energy recovery circuit supplies the sustain voltage, the energy recovery circuit supplies a falling pulse gradually falling from the sustain voltage to a reference voltage to the second electrode.

20. The method of claim 16, wherein the first surface discharge is generated by supplying a predetermined voltage to the first electrode for a first duration of time, and by supplying the sustain voltage to the second electrode for a second duration of time, and
a portion of the first duration of time overlaps a portion of the second duration of time.

21. The method of claim 16, wherein the second surface discharge is generated by supplying a predetermined voltage to the first electrode for a first duration of time, and by supplying a reference voltage to the second electrode for a second duration of time, and
a portion of the first duration of time overlaps a portion of the second duration of time.

22. The method of claim 16, wherein the subfield is located subsequent to a first located subfield of a frame.

23. A method of driving a plasma display apparatus comprising a first electrode, a second electrode and a third electrode, comprising:
supplying a voltage of a first polarity to the first electrode and supplying a voltage of a second polarity to the second electrode during a reset period of a first subfield to generate a first surface discharge;
generating a second surface discharge between the first electrode and the second electrode during the reset period of the first subfield;
generating a first opposite discharge between the first electrode and the third electrode during the reset period of the first subfield;
generating a third surface discharge between the first electrode and the second electrode during a reset period of a second subfield; and
generating a fourth surface discharge weaker than the third surface discharge between the first electrode and the second electrode during the reset period of the second subfield,
wherein the third surface discharge is generated by supplying a sustain voltage to the second electrode, and the fourth surface discharge is generated by supplying a reference voltage to the second electrode.

24. The method of claim 23, wherein the first subfield and the second subfield are located adjacent to each other.

25. The method of claim 23, wherein a sustain period of the first subfield is adjacent to a reset period of the second subfield.
